(19) United States
(12) Patent Application Publication
(10) Pub. No.: US 2012/0119170 A1
(43) Pub. Date: May 17, 2012

(54) COLOR CHANGING POLYMER-BASED ARTICLE

(75) Inventor: Ori Faran, Haifa (IL)

(73) Assignee: SKYRAD LTD., Nesher (IL)

(21) Appl. No.: 13/386,739

(22) PCT Filed: Jul. 21, 2010
(86) PCT No.: PCT/IL2010/000577

§ 371 Date: Jan. 24, 2012

Related U.S. Application Data
(60) Provisional application No. 61/228,163, filed on Jul. 24, 2009.

(51) Int. Cl. G02B 5/23; B29C 45/16

(52) U.S. Cl. 252/586; 264/328.18

(57) ABSTRACT

A polymer-based color changing article manufactured by injection, extrusion or similar methods that comprises transparent polymer matrix, polymeric color changing enhancer additive distributed within the polymer matrix that does not change its optical properties and a chemical compound capable of reversible changing its original color due to a photochemical reaction. The polymer-based color changing article can be used for applications such as lenses, color changing protective shields or sheets for controlling the intensity of light irradiation within a room, car, greenhouse, games, toys, memorabilia, packages for light sensitive food, beverages, and drugs.

### BACKGROUND OF THE INVENTION

The ability of a chemical compound to change color when it is irradiated with electromagnetic radiation (particular ultraviolet range), and then returning to its original color when the irradiation is terminated, is referred to as photochromism. There are many applications that can make use of such compounds, for example film coating for windows, packages, optical objects, lenses, toys, etc.

There are two main obstacles in the way of mass production and use of such applications. The first one is the high price of products due to the expensive method of production. The second one is the technological limitations existing in using some commercial polymers that in term limit the possible uses of such products. These problems could be overcome by using injection molding or extrusion. These methods will also enable the use of polymers such as polycarbonate, PMMA, and polyurethane which are stronger and much cheaper, and will enable production of more photochromic applications that demand the use of such polymers. For example, one of the known applications of photochromic technology is color changing lenses.

The technology used today for manufacturing of color changing lenses is polymerization of special acrylic monomers rather than injection. This method is very slow and expensive. Since it involves cast of liquid expensive monomers in glass molds, and curing for 24 hours in oven at 80 deg. These cause the price to be high and hence the use of such lenses to be limited.

The reason why injection is not in use today for this application is due to the poor results, mainly slow color change and small change of light transmission.

The present invention enables to achieve the same performance as in cast molding but with a much lower cost, by adding special additives to non expensive commercial polymers, and using injection as the production method. The option to use many polymers will also enable manufacturing of strong color changing lenses as an example, for applications such as protective and sport. There are patents disclosing color changing lenses made by injection molding. These patents disclosing production of lenses using a complex structure, mainly film attach to the injected lens. Examples of these patents are:

U.S. Pat. Nos. 5,531,940, 5,998,520, 6,065,836, 7,314,590, 7,350,917.

WO patents no. 2001/049478, 2003/078148, 2004/011235, and 2008/133342.

The main problems associated with these patents are:

1. The layer that contains the photo changing compound is the outer layer of the lens; this makes the lens very sensitive to scratch.

2. Due to the small thickness of the active layer, the require concentration of photo changing compound is much larger then in molding, which makes them more expensive.

3. Since the color change compound is very sensitive to heat, and most of the heat is concentrated in the coated layer, the life span of such lenses is much less compared to the injected lenses.

There are also known patents disclosing color changing film/toys made by injection/extrusion molding. For example, U.S. Pat. Nos. 5,166,345, 6,846,934. However, there is a use of complex and expensive color changing compounds that have limited results.

### SUMMARY OF THE INVENTION

It is an object of the present invention to provide a simple, economical, and efficient way to manufacture improved color changing articles by injection or extrusion.

In order to make the color changing effect significant while using the conventional color changing compounds, there is a need for a specific matrix composition containing special color changing polymeric additive (polymeric color changing enhancer additive) compatible to the polymer in use.

The particular compounds are chosen so they can withstand high temperature, in order to enable employing many types of polymers, and to use industrial fabrication methods suitable for mass production.

It is therefore provided in accordance with a preferred embodiment of the present invention a polymer-based color changing article manufactured by injection, extrusion or similar methods comprising:
substantially transparent polymer matrix;
at least one polymeric color changing enhancer additive distributed within said polymer matrix wherein said at least one polymeric color changing enhancer additive does not change its optical properties;
at least one chemical compound capable of reversible changing its original color due to a photochemical reaction.

Furthermore and in accordance with another preferred embodiment of the present invention, said substantially transparent polymer matrix is selected from a group of polymers such as polyolefines, polystyrenes, polyacrylate derivatives, polyvinyl derivatives, polycarbonate derivatives, polyester derivatives, cellulose derivatives, taken alone or in any combination thereof.

Furthermore and in accordance with another preferred embodiment of the present invention, said at least one polymeric color changing enhancer additive is selected from a group of additives such as aliphatic esters, aromatic esters, taken alone or in any combination thereof.

Furthermore and in accordance with another preferred embodiment of the present invention, said at least one chemical compound is selected from a group of compounds such as spiropyranes, spiroxazines, naphthopyrans, taken alone or in any combination thereof.

Furthermore and in accordance with another preferred embodiment of the present invention, the article comprises a color agent.

Furthermore and in accordance with another preferred embodiment of the present invention, the article comprises a UV absorber.

Furthermore and in accordance with another preferred embodiment of the present invention, the article comprises a stabilizer.

Furthermore and in accordance with another preferred embodiment of the present invention, said at least one chemical compound establishes 0.02 to 1 weight percent of the article.

Furthermore and in accordance with another preferred embodiment of the present invention, at least one polymeric color changing enhancer additive establishes 1 to 50 weight percent of the article.

Furthermore and in accordance with another preferred embodiment of the present invention, said at least one chemical compound can stand a manufacturing temperature up to 260 degrees Celsius.

Furthermore and in accordance with another preferred embodiment of the present invention, said photochemical reaction is a UV reaction.

In addition and in accordance with another preferred embodiment of the present invention, the article can be used for applications such as lenses, color changing protective shields or sheets for controlling the intensity of light irradiation within a room, car, greenhouse, games, toys, memorabilia, packages for light sensitive food, beverages, drugs.

### BRIEF DESCRIPTION OF THE DRAWINGS

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 presents the general formula of Spiroxazines derivatives to be used in accordance with a preferred embodiment of the present invention.

FIG. 2 presents the general formula of Spiropyrans derivatives to be used in accordance with a preferred embodiment of the present invention.

FIG. 3 presents the chemical reaction of the derivatives represented in FIGS. 1 and 2 responsible for the change of color.

FIG. 4 presents the general formula of Naphthopyrans derivatives to be used in accordance with a preferred embodiment of the present invention.

FIG. 5 represents a general formula of aromatic ester to be used in accordance with a preferred embodiment of the present invention.

### DETAILED DESCRIPTION OF THE PREFERRED EMBODIMENTS

It has been empirically established that the polymer-based articles of the present invention should satisfy the following criteria in order to advantageously improve the existing articles:
1. The article should be capable of undergoing photochemical reaction in response to the UV radiation which will cause significant change in the visible range transmission.
2. The compound should be able to undergo direct and reverse photochemical reaction, without significant decrease performance after continued exposure for at least six month in the sun.
3. The color changing compound and all other additives should withstand manufacturing temperature of up to 260° C.

Some non-exhaustive representative examples of various compositions comprising suitable photochromic compounds are listed below:

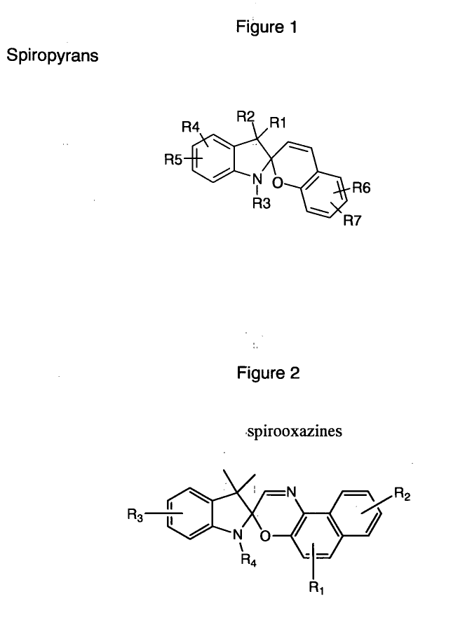

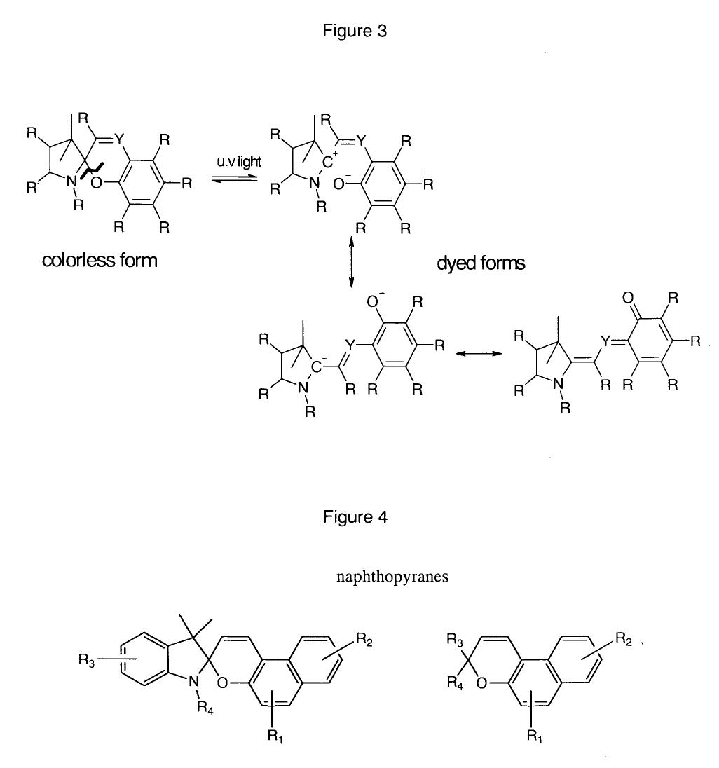

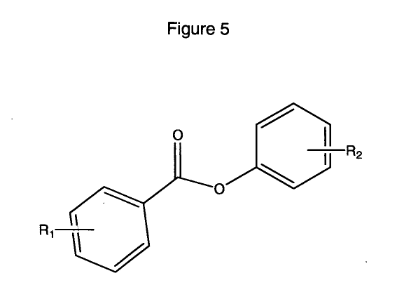

a) Spiroxazines and Spiropyrans derivatives represented by the general formula shown in FIG. 1 and FIG. 2. In the general formulas, R₁, R₂, R₃, R₄, R₅, R₆, R₇ represent independently an alkyl group, an aromatic group, an alkoxy group, a nitro group or a halogen. An example of the formulas is described in Nori, Y. C. Can. J. Chem., 61, 300 (1983). The chemical reaction responsible for the change in color is presented with reference to FIG. 3.

b) Naphthopyrans derivatives represented by the general formula shown in FIG. 4. In the above formula, X═O, S, N—R₁, (CH₂)ₙ and n=0, 1, 2, etc. R₁, R₂, R₃, R₄, R₅, R₆ represent independently an alkyl group, an alkoxy group, a nitro group or a halogen. R₃-R₄, R₅-R₆ can also represent independently only a sole group, like an aromatic group, an alkoxy or thioaromatic group, for example as described in Van Germert, B Mol. Cryst. Liq. Cryst., 1997, Vol. 297, p. 131. The chemical reaction responsible for the change in color is presented with reference to FIG. 3

### Example 1

An article with a 0.05% weight color changing compound Spiro[2H-indole-2,3′-[3H]naphth[2,1-b][1,4]oxazine], 6′-(2,3-dihydro-1H-indol-1-yl)-1,3-dihydro-1,3,3-trimethyl, and 1% weight of UV stabilizer nickel dithiocarbamate and 10% Elvaloy 3427 were added to CH207 PMMA. The mixture were then compounded at 220° C., and then injected to obtain the desired article.

The initially white colored article was changed into blue color after exposure to the sun light for a few seconds. The color faded in about a few minutes after the article was removed from the sunlight.

### Example 2

A lens with a 0.5% weight of color changing compound Spiro[2H-indole-2,3′-[3H]naphth[2,1-b][1,4]oxazine], 6′-(2,3-dihydro-1H-indol-1-yl)-1,3-dihydro-1,3,3-trimethyl, and 0.05% weight of UV stabilizer nickel dithiocarbamate and 0.05% weight and 1% SUN were added to the PC markrolon 2207 by compounding at 240° C. with subsequent injection molding to obtain the desired toy form:

The initially colorless article was changed into blue color after exposure to the sun light for a few seconds. The color faded in a minute after the article was removed from the sun light.

In practice, the color changing articles of the present invention are made of an optically transparent polymeric material (base matrix) chosen from the group comprising polyolefin's, polystyrenes, polyacrylates, polyvinyl derivatives, polyester derivatives, cellulose derivatives etc. taken alone or in any combination thereof. The base composition consists also of special polymeric color changing enhancer additive such as aliphatic or aromatic esters. The base composition can comprise also stabilizers and UV absorbers and if needed, a color agent to increase or to change the initial or final color. The preferred manufacturing method for the articles production is injection molding or extrusion. Example of a stabilizer is nickel complex such as nickel ditiocarbomate, Example of an absorber is 2-hydroxy-4-(N-octoxy)benzophenone. Examples of such organic color agents suitable for this purpose include Phtalocyanine, Quinacridone, Isoindolinone, Perylene, Anthraquinone, etc.

It should be appreciated that the present invention is not limited by the above-described embodiments and that changes and modifications can be made by one ordinarily skilled in the art without deviation from the scope of the invention as will be defined below in the appended claims.

Applications of the color changing articles corresponding to the present invention are various and can be also contemplated. For example, one can contemplate, lenses, color changing protective shields or sheets which can control the intensity of sun radiation within a room, car, greenhouse etc. Another example could be in the category of games, toys or memorabilia.

Still, further possible application of the invention can be packages for light sensitive food, beverages, drugs etc. so as to prevent their exposure to UV radiation or high intensive visible radiation outside, while allowing inspection of the interior by transparency or the package or part of it when the product is in indoor.

It should be appreciated that features disclosed in the foregoing description, and/or in the following claims, and/or examples, may both separately and in any combination thereof, be material for realizing the present invention in diverse forms thereof.

1. A polymer-based color changing article manufactured by injection, extrusion or similar methods comprising:
substantially transparent polymer matrix;
at least one polymeric color changing enhancer additive distributed within said polymer matrix wherein said at least one polymeric color changing enhancer additive does not change its optical properties;
at least one chemical compound capable of reversible changing its original color due to a photochemical reaction.

2. The article as claimed in claim 1, wherein said substantially transparent polymer matrix is selected from a group of polymers such as polyolefines, polystyrenes, polyacrylate derivatives, polyvinyl derivatives, polycarbonate derivatives, polyester derivatives, cellulose derivatives, taken alone or in any combination thereof.

3. The article as claimed in claim 1, wherein said at least one polymeric color changing enhancer additive is selected from a group of additives such as aliphatic esters, aromatic esters, taken alone or in any combination thereof.

4. The article as claimed in claim 1, wherein said at least one chemical compound is selected from a group of compounds such as spiropyranes, spiroxazines, naphthopyrans, taken alone or in any combination thereof.

5. The article as claimed in claim 1, further comprising a color agent.

6. The article as claimed in claim 1, further comprising a UV absorber.

7. The article as claimed in claim 1, further comprising a stabilizer.

8. The article as claimed in claim 1, wherein said at least one chemical compound establishes 0.02 to 1 weight percent of the article.

9. The article as claimed in claim 1, wherein at least one polymeric color changing enhancer additive establishes 1 to 50 weight percent of the article.

10. The article as claimed in claim 1, wherein said at least one chemical compound can stand a manufacturing temperature up to 260 degrees Celsius.

11. The article as claimed in claim 1, wherein said photochemical reaction is a UV reaction.

12. The article as claimed in claim 1, wherein the article can be used for applications such as lenses, color changing protective shields or sheets for controlling the intensity of light irradiation within a room, car, greenhouse, games, toys, memorabilia, packages for light sensitive food, beverages, drugs.
